(19) United States
(12) Patent Application Publication
(10) Pub. No.: US 2006/0161886 A1
(43) Pub. Date: Jul. 20, 2006

(54) Three-Layer Property Implementation for Codeless Programming

(75) Inventor: David Wei Ge, Kirkland, WA (US)

Correspondence Address: DAVID GE, 10218 125TH AVE. NE, KIRKLAND, WA, 98033, US

(73) Assignee: Dr. David Wei Ge, Kirkland, WA (US)

(21) Appl. No.: 10/905,733

(22) Filed: Jan. 19, 2005

(51) Int. Cl. G06F 9/44

(52) U.S. Cl. 717/106; 717/104

(57) ABSTRACT

A three-layer property implementation for the purpose of generic-purpose codeless programming is invented. Layer-3 is a property description class for implementing design time features for the user to do codeless programming; layer-2 is a property class for implementing property attributes including how the property value should be retrieved; layer-1 is an object of any data type for implementing property value. Method parameters are implemented in property description class so that codeless programming at design time is possible. Action parameters are implemented in property class so that correct property values can be retrieved. Event arguments are exposed via property description classes so that codeless programming involving event arguments is possible.

### BACKGROUND OF INVENTION

This invention relates to generic-purpose codeless-programming techniques. Universities, companies and individuals have been trying many approaches in this field. In some specific application areas, codeless programming has achieved excellent results.

In the application area of geoscientific analysis, GeoVISTA Studio from the Pennsylvania University provides an environment that operationally integrates a wide range of analysis activities. (http://www.geovistastudio.psu.edu)

In the area of database applications, Sunopsis v3 delivers a codeless programming environment for the rapid development, implementation, and management of the required data management processes, in either batch or real time. (http://www.sunopsis.com/corporate/us/news/announce_{—}72.htm).

In the application area of Enterprise Resource Planning (ERP), ERPWEB is an open source codeless ERP developed by ASIC Infotech Pvt, Ltd. According to Shah, manager-business development/support, ASIC Infotech, “Gartner predicts Codeless Programming tools in the market only by 2013, but we're already here—Oracle too is trying to innovate a tool on similar lines.” (http://www.cxotoday.com Dec. 24, 2004). In the ERP area, Codeless Technology B.V. also developed a product named Codeless which is based on Model Driven Architecture (MDA) (http://www.codeless.com/). Another codeless ERP product is JAZZ (http://service.comson.com/comdex2002/htm.ieuraesol/Eurae_jazzX.pdf

We can see that even in a single application area, codeless programming is very difficult, but it is also much desired in the industry.

For generic purpose codeless programming, there are also many research results. Among these achievements, Professor Don Batory, Department of Computer Sciences, University of Texas at Austin, presents Feature Oriented Programming (FOP) (http://www.cs.utexas.edu/users/schwartz/Started.html) and Product-Line Architecture (PLA ftp://ftp.cs.utexas.edu/pub/predator/frameworks.pdf). These research results are trying to pave the way to reach the next generation of software engineering, and codeless-programming is among the goals.

Microsoft may be doing research on codeless programming, but no results published yet (http://news.bbc.co.uk/1/hi/business/603985.stm).

Traditional programming systems are also producing codeless-programming features, for example, SmallTalk, Java Studio, etc.

Softwire Technology (http://www.softwire.com/) developed a product named SoftWIRE which is to be used in Microsoft Visual Studio NET environment. SoftWIRE uses specifically built components as programming blocks, and link the components by “wires”. This product is interesting but it is a VB assistant tool, not an independent programming system. U.S. Pat. No. 5,862,379 uses a link class to link between C++ classes and uses a commercially available script language to define link attributes, and thus built a visual programming environment. Involving a script language makes it not a true codeless programming system. Similar to SoftWIRE and U.S. Pat. No. 5,862,379, U.S. Pat. No. 5,850,548 defines “ports” for linking of software components, and thus built a visual programming system. The “port” allows one property change in one component to pass to the property of the other component. The types of property values are primary data types. Limiting to primary data types will severely limit the capability of such a programming system. Limiting application flow to property changes is inconvenient to component development and put a limitation to the types of components.

Almost all current programming systems have some kinds of codeless programming features. But all such features are far away from the expectations. Dino Esposito, a lecturer in programming, says: “I believe that codeless applications will never be a reality.” (http://weblogs.asp.net/despos/archive/2003/11/28/40193.aspx). This invention forms a foundation for true codeless applications.

From the published researches and from the industry practice, it is clear that component-based programming is the direction of future software engineering.

For codeless component-based programming, one key issue is the data-passing between components. All researches, technologies, methods, and products in the field of codeless/visual programming have limitations on handling data transferring between software components. When Java Bean is generating event linking code in codeless programming there is not event arguments used. U.S. Pat. No. 5,850,548 limits data passing to primary data types. For a codeless programming system without a unified data passing technique which does not limit data types, the programming can only be done for the supported data types and thus for specific application areas.

This invention uses a 3-layer property implementation technique, together with action and action list techniques, to form a codeless programming system. Because this is a unified data passing technique which supports unlimited data types, the codeless programming system based on this technique can be for generic-purpose application development, not limiting to certain application areas.

### SUMMARY OF INVENTION

In general, in one aspect the invention is a three-layer property implementation for codeless programming. This implementation supports unlimited data types in data transferring between software components, and supports generic-purpose complete codeless programming. Layer-3 is the property attributes for codeless programming; layer-2 is the property attributes about the property value; layer-1 is the property value which can be of any data types.

In general, in another aspect the invention is a component-based codeless programming tool and application execution environment that uses layer-3 to implement software component properties, uses layer-3 to implement parameters for methods of software components, uses layer-3 to implement public event arguments, and uses layer-2 to implement action parameters. The user uses the design time attributes of layer-3 to set component properties and set action parameters. At runtime, the execution environment uses property value attributes of layer-2 to retrieve property values as action parameters and passing data between software components.

These new techniques used in this invention address the problem of unified and data-type-unlimited data transferring between software components and thus form a foundation for generic-purpose codeless programming.

### BRIEF DESCRIPTION OF DRAWINGS

FIG. 1 shows the toolbox window showing all types of software components. The user selects component types to create new software component instances in application development.

FIG. 2 shows the property window at design time. The property window shows all properties of a software component.

FIG. 3 shows the Action-Data dialogue box. It uses design time features of layer-3 property implementation to set action parameters.

FIG. 4 shows the use of event arguments in codeless programming.

FIG. 5 shows that an action list object named ShowMousePosition is linked to MouseMove event of a form component.

FIG. 6 shows a snapshot of one moment of mouse movement for a sample application which uses mouse event arguments in codeless programming.

FIG. 7 shows an event map of an application.

### DETAILED DESCRIPTION

This invention uses a three-layer property implementation to address the problem of unified and data-type-unlimited data transferring between software components and thus forms a foundation for generic-purpose codeless programming.

An implementation of this invention is a generic-purpose codeless programming system named Limnor, see http://www.limnor.com. The programming system runs on Microsoft Windows XP or above with 256 MB RAM and 100 MB free hard disk space.

Software Component Definition

The implemented system, Limnor, is developed in C#. Software component is implemented by an interface IPerformer which exposes properties, methods and events via 3-layer property implementation.

The properties, methods and events are designed specifically for codeless programming and for unlimited extensions when existing object types for properties, methods and events do not meet programming needs. The component properties are implemented via 3-layer property implementation. The method parameters are implemented via 3-layer property implementation. The event arguments are exposed via component properties for codeless programming.

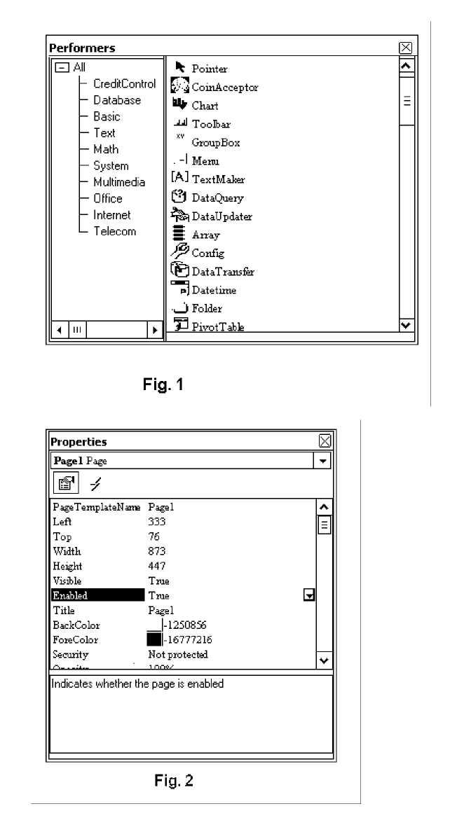

All types of software components are displayed in a toolbox window for the user to create component instances in application development. See FIG. 1 for the toolbox window.

IPerformer interface is defined as following

```
    public interface IPerformer : IProperties
    {
        //---Generic interface------------------------------------------
        /// <summary>
        /// component version. It can be used to make component backward compatible.
        /// </summary>
        System.Int16 Version{get;}
        /// <summary>
        /// Set by platform. For Page component and Application component it is 0.
For other component it is Page ID, or 0 for Application component.
        /// </summary>
        int ParentID {get;set;}
        /// <summary>
        /// called when language changes.
        /// </summary>
        void OnLanguageChange( );
        /// <summary>
        /// called when creating a new instance in the application by the user
        /// </summary>
        void setDefault( );
        /// <summary>
        /// called after loading from storage
        /// </summary>
        void OnDeserialize( );
        /// <summary>
        /// set variable
        /// </summary>
        /// <param name=“dataName”>variable name</param>
        /// <param name=“data”>value to assign to the variable</param>
        void setRunData(string dataName, object data);
        /// <summary>
        /// get variable
        /// </summary>
        /// <param name=“dataName”>variable name</param>
        /// <returns>variable value</returns>
        object getRunData(string dataName);
        /// <summary>
        /// run-mode/design-mode changed
        /// </summary>
        /// <param name=“bRun”>true:changed to runtime;
        /// false: change to design time</param>
        void OnModeChange(bool bRun);
        /// <summary>
        /// called when the component is no longer needed and will be removed from
memory.
        /// component should clean up resources
        /// </summary>
        void OnClosing( );
        /// <summary>
        /// called when query changed. If the component is bound to the query
        /// then this function should repopulate with the query data.
        /// </summary>
        void OnRebindData( );
        /// <summary>
        /// set by framework for nested controls
        /// </summary>
        IEPUIDesigner GroupOwner{get;set;}
        //
        //---Methods----------------------------------------------------
        /// <summary>
        /// returns the number of methods
        /// </summary>
        /// <returns>method count</returns>
        int getMethodCount( );
        /// <summary>
        /// get method object (usually a static object)
        /// </summary>
        /// <param name=“index”>method index</param>
        /// <returns>method object</returns>
        clsMethod getMethod(int index);
        //
        /// <summary>
        /// This function is called by Limnor when the user creates a new action.
        /// Limnor calls this function before showing Action-Data dialog box. You may
use
        /// your own dialog box to set action parameters.
        /// </summary>
        /// <param name=“Method”>The method for creating the action</param>
        /// <param name=“objAct”>the action object</param>
        /// <returns>OK: the parameters are set in objAct;
        /// Cancel/Abort: abort the operation;
        /// other: call framework's Action-Data dialog to set the parameters
</returns>
        DialogResult SetActionParameters(clsMethod Method,clsAction objAct);
        /// <summary>
        /// Called by the Limnor when the user sets the method parameter.
        /// </summary>
        /// <param name=“Method”>the method whose parameters are assigned value via
design UI</param>
        void OnSetMethodParameter(clsMethod Method);
        /// <summary>
        /// action execution at runtime
        /// </summary>
        /// <param name=“objAction”>the action to execute</param>
        /// <param name=“sender”>the component invoking the action, usually
        /// it is the component firing an event which invoked this action</param>
        /// <param name=“e”>the event argument for the event invoking this
action</param>
        void DO(clsAction objAction,object sender,EPSTDEventArgs e);
        //
        //--------------------------------------------------------------
        //---Event------------------------------------------------------
        /// <summary>
        /// returns the number of events
        /// </summary>
        /// <returns> number of events </returns>
        int getEventCount( );
        /// <summary>
        /// returns event object by event array index
        /// </summary>
        /// <param name=“Index”>event array index</param>
        /// <returns>event object</returns>
        IEvent getEventByIndex(int Index);
        /// <summary>
        /// returns event object by event ID
        /// </summary>
        /// <param name=“eventID”>event ID</param>
        /// <returns>event object</returns>
        IEvent getEventByID(int eventID);
        /// <summary>
        /// returns event name
        /// </summary>
        /// <param name=“eventID”>event ID</param>
        /// <returns>event name</returns>
        string getEventNameByID(int eventID);
        /// <summary>
        /// returns event description
        /// </summary>
        /// <param name=“eventID”>event ID</param>
        /// <returns>event description</returns>
        string getEventDescByID(int eventID);
        //--------------------------------------------------------------
    }
    //---end of IPerformer---
```

IProperties interface is defined as following

```
    public interface IProperties
    {
        /// <summary>
        /// property count. may be implemented as a static member or const
        /// </summary>
        int Count{get;}
        /// <summary>
        /// returns property name. property names may be implemented as static string
array.
        /// </summary>
        /// <param name=“index”>property index</param>
        /// <returns>property name</returns>
        string GetPropertyName(int index);
        /// <summary>
        /// returns property description. property descriptions may be implemented as
static string array.
        /// </summary>
        /// <param name=“index”>property index</param>
        /// <returns>property description</returns>
        string GetPropertyDesc(int index);
        /// <summary>
        /// get property description object, property value reflects the owner's
state.
        /// </summary>
        clsPropertyDesc this [int index]{get;}
        /// <summary>
        /// get property description object to access property attributes, property
value might not reflect the owner's current state
        /// </summary>
        /// <param name=“index”>property index</param>
        /// <returns>property description object</returns>
        clsPropertyDesc GetDescObject(int index);
        /// <summary>
        /// called after a property value changes.
        /// Property value already changed.
        /// </summary>
        /// <param name=“index”>property index</param>
        /// <param name=“rawData”>the property value</param>
        /// <param name=“bReload”>true:property window needs refresh</param>
        void OnPropertyChange(int index,object rawData,ref bool bReload);
        /// <summary>
        /// indicate whether the properties changed or not
        /// </summary>
        bool Changed{get;set;}
        /// <summary>
        /// Set property value.
        /// </summary>
        /// <param name=“index”>property index</param>
        /// <param name=“key”>for a multi-valued property, key is used to identify
the value</param>
        /// <param name=“oValue”>the value to be used</param>
        void setProperty(int index,object key,object oValue);
        /// <summary>
        /// get property value
        /// </summary>
        /// <param name=“index”>property index</param>
        /// <param name=“key”>for a multi-valued property, key is used to identify
the value</param>
        /// <returns>property value</returns>
        object getProperty(int index,object key);
    }
    //---end of IProperties---
```

Property Implementation

A clsPropertyDescclass or its derived class provides programming attributes relating to the component the property belongs to and used for codeless programming; it controls how to display the property in property list (see FIG. 2) and how to show UI to set property. For more examples of such codeless programming attributes, see an implementation below in section “Basic Property Classes”. We call it a property description class (PDC). A clsPropertyDescclass or its derived class contains a public member named objproperty which is a clsPropertyclass or its derived class. clspropertyclass provides attributes about the property value; it controls how the property value is retrieved; is the property a multi-valued or single valued property. It also indicates which component the property belongs to. For more examples of property value attributes, see an implementation below in section “Basic Property Classes”. We call it a property class (PC).

A clspropertyclass or its derived class contains a protected member named oValue which is of object type. oValue is the property value (PV). Property values are the values to be used by component code. Property class and property description class are for realizing codeless programming.

In this implementation, property value is layer-one, property class is layer-two, and property description class is layer-three.

For every type of property value, we need to use a corresponding property class to hold it.

For every type of property class, we need to use a corresponding property description class to hold it. But the relationships do not need to be one-to-one.

When a property description object is created, the property object, objProperty is automatically created. When a property object is created, the property value object, oValue, is automatically created. In this way a property description class always has a property class member it knows how to handle, and a property class always has a property value type it knows how to handle.

Basic Property Classes

The primary data types, string and date/time are supported by the base property class clsProperty. The base property description class is clsPropertyDesc.

| | | Property Description |
|---|---|---|
| Property Value types | Property class | Class |
| primary types, string, | clsProperty | clsPropertyDesc |
| and DateTime | | |

clsPropertyDesc:

Attributes describing how the property is used by a component for codeless programming:

//Layer-3 attributes and codeless programming features implemented by Limnor system
//it is the index into the property array for a component
protected int nIndex = 0;
//it indicates whether the property is read-only at design time
public bool bReadOnly=false;
//it is set by Limnor framework in situations like changing security
public bool bDynamicReadOnly=false;
//it indicates whether the property is read-only at runtime
public bool bRuntimeReadOnly=false;
//its bits contain other attributes for programming.
//For now only 2 bits are used. bit 1: the property is a component name; bit 2: the property is for the first
parameter of “Set property” method
public int nAttributes=0;
//it indicates whether this property should appear in the property window when multiple components are selected
at design time
protected bool bCommon=false;
//it is the instance of property class (layer-2)
public clsProperty objProperty=null;
/// <summary>
/// gets a list for property value selection
/// </summary>
/// <returns>array for property value selection; return null if no selection list for this property</returns>
public virtual stPropertySelection[ ] GetSelectionList( );
/// <summary>
/// gets index for the value selected if the property has a value selection list
/// </summary>
/// <returns>index for the value selected;−1 if no value selected or if the property does not have a selection
list</returns>
public virtual int SelectIndex( );
/// <summary>
/// shows property value setting dialogue box
/// </summary>
/// <param name=“frmOwner”>the form calling this function</param>
/// <param name=“retValue”>the property value selected</param>
/// <returns>true: a property is selected; false: the user canceled the dialogue box, or a dialogue box is not
supported</returns>
public virtual bool showSelectionDialog(System.Windows.Forms.Form frmOwner,ref object retValue);
/// <summary>
/// in property window it draws a picture to represent the property value
/// </summary>
/// <param name=“g”>the destination to draw on</param>
/// <param name=“rc”>the drawing area on the destination</param>
/// <returns>width of the drawing</returns>
public virtual int drawCellIcon(System.Drawing.Graphics g, System.Drawing.Rectangle rc);
/// <summary>
/// determines whether in-place-editing is allowed or not
/// </summary>
/// <returns>true: user may type in property value in the property window;
/// false: user cannot type in property value</returns>
public virtual bool allowInPlaceEditing( );
/// <summary>
/// determines whether the property supports property setting dialogue box or not
/// </summary>
/// <returns>true: supported, function showSelectionDialog is implemented; false: not supported</returns>
public virtual bool useSelectionDialog( );
/// <summary>
/// gets the image to represent the property
/// </summary>
/// <returns>the image to represent the property</returns>
public virtual Bitmap getCellButtonImage( );
/// <summary>
/// determines whether the property is read-only
/// </summary>
/// <returns>true: read-only</returns>
public virtual bool getReadOnly( );
/// <summary>
/// sets read-only attributes
/// </summary>
/// <param name=“b”>true: read-only</param>
public virtual void setReadOnly(bool b);
/// <summary>
/// gets runtime read-only attribute
/// </summary>
/// <returns>runtime read-only attribute</returns>
public virtual bool RunTimeReadOnly( );
/// <summary>
/// gets a string for displaying the property in the property window
/// </summary>
/// <returns>a string for displaying the property in the property window</returns>
public virtual string ToDispString( );
/// <summary>
/// gets a string representation of the property
/// </summary>
/// <returns>a string representation of the property</returns>
public override string ToString( );

Constructor:

public clsPropertyDesc(int idx,bool commonProp,object sample)

Parameters:

idx: This is the property index into the property array for the component. It is assigned to variable nIndex.

commonProp: It is assigned to variable bCommon, indicating whether the property should appear in the property window when multiple components are selected at design time.

sample: the type of this parameter determines the type of the property value. It is assigned to variable oValue of the objProperty object. If you want to create a string property then sample should be a string; if you want to create an integer property then sample should be an integer; etc. Derived property description classes may choose to ignore this parameter or convert this parameter to the right data type for the property value. This constructor should be used in a component to create property objects.

clsProperty:

Attributes and functions:

```
//Layer-2 attributes and codeless programming features implemented
by Limnor system
//owner of the property. It is the software component owning the property.
public IPerformer owner=null;
//it is the property value for the property (layer-1)
protected object oValue=null;
/// <summary>
/// indicates whether the property has more than one value.
/// </summary>
public virtual bool IsMultipleValued( );
/// <summary>
/// Test whether a given type is compatible with the property value
/// </summary>
/// <param name=“tp”>the type to test</param>
/// <returns>true: compatible; false: not compatible</returns>
public virtual bool IsCompatible(System.Type tp);
/// <summary>
/// Use this virtual function to create clones
/// </summary>
/// <returns>a cloned clsProperty or its derived class</returns>
public virtual clsProperty Clone2( );
/// <summary>
/// implementing ICloneable interface
/// </summary>
/// <returns>cloned property object</returns>
object ICloneable.Clone( )
{
    return Clone2( );
}
/// <summary>
/// usually it just returns oValue itself.
/// Compare this function to getCoreValue, which returns the
/// date oValue pointing to, if oValue points to another value.
/// </summary>
/// <returns>property value</returns>
public virtual object getValue( );
/// <summary>
/// The property value may be pointing to another value.
/// This method should return what it points to.
/// If oValue does not point to another value, this method
/// should return oValue
/// </summary>
/// <returns>property value</returns>
public virtual object getCoreValue( );
/// <summary>
// for a multi-valued property, use this function to get a single property
value identified by key
/// </summary>
/// <param name=“key”>index into multi-valued property value</param>
/// <returns>the single value identified by key</returns>
public virtual object getCoreValue(object key);
/// <summary>
/// Set property value
/// </summary>
/// <param name=“oVal”>the value to use</param>
/// <returns>true: the value is assigned to the property value,
/// meaning that the value to use is compatible to the property</returns>
public virtual bool setProperty(object oVal);
/// <summary>
/// Set property value for multi-valued properties
/// </summary>
/// <param name=“key”>the index into multi-valued
property value</param>
/// <param name=“oVal”>the value to use</param>
/// <returns>true: the value is assigned to the property value,
/// meaning that the value to use is compatible to the property</returns>
public virtual bool setProperty(object key,object oVal);
/// <summary>
/// Change oValue to oVal, not just convert value from oVal.
/// This is for Action Parameters to take object values of types
/// clsPropPerformerProp and clsPropEventData
/// </summary>
/// <param name=“oVal”>object to be assigned to oValue</param>
public virtual void setTypeAndValue(object oVal)
{
    oValue = oVal;
}
/// <summary>
/// it is for displaying the property in property editing windows
/// </summary>
/// <returns>string representing the property</returns>
public virtual string ToDispString( );
/// <summary>
/// it is for updating property from editing window
/// </summary>
/// <param name=“s”>the string to be converted to oValue</param>
public virtual void FromString(string s);
```

Property Classes for Other Data Types

The property types below are implemented in Limnor. Software component developers may use them in developing components. Many properties are for NET framework types, for those types we do not provide descriptions here. Please refer to Microsoft NET framework for their descriptions.

When a new software component needs to use a new property value types not listed here, a new property class may be derived from clsproperty, or a new property description class may be derived from clsPropertyDesc to support the new value type.

| | Property class/Property | |
|---|---|---|
| Property Value types | Description Class | Description |
| System.Drawing.Color | clsEPcolor/clsEPcolorDesc | For Color properties |
| clsPerformerActions | clsPropActions/ | For the first parameter of |
| | clsPropActionsDesc | AssignActions method |
| System.Windows. | clsPropAnchor/ | |
| Forms.AnchorStyles | clsPropAnchorDesc | |
| bool | clsProperty/clsPropBoolDesc | boolean |
| System.Windows. | clsPropBorderStyle/ | |
| Forms.BorderStyle | clsPropBorderStyleDesc | |
| EPCursor | clsPropCursor/ | For Cursor property |
| | clsPropCursorDesc | |
| System.Windows. | clsPropDockStyle/ | |
| Forms.DockStyle | clsPropDockStyleDesc | |
| clsDrawingList | clsPropDrawings/ | Drawing list used in a Page |
| | clsPropDrawingsDesc | |
| String | clsPropDrive/ | Disk drive |
| | clsPropDriveDesc | |
| clsEventID | clsPropEvent/ | Identifying an Event |
| | clsPropEventDesc | |
| MultiLangString | clsPropFile/clsPropFileDesc | File path. |
| clsFileList | clsPropFileList/ | File list |
| | clsPropFileListDesc | |
| System.Windows. | clsPropFlatStyle/ | |
| Forms.FlatStyle | clsPropFlatStyleDesc | |
| String | clsProperty/clsPropFolderDesc | Folder |
| clsEPFont | clsPropFont/clsPropFontDesc | Font |
| System.Windows.Forms. | clsPropHorizontalAlig/ | |
| HorizontalAlignment | clsPropHorizontalAligDesc | |
| int | clsProperty/ | Image index for an image list |
| | clsPropImageIndexDesc | |
| int | clsPropLanguage/ | Language id |
| | clsPropLanguageDesc | |
| System.Windows.Forms. | clsPropListSelmode/ | |
| SelectionMode | clsPropListSelmodeDesc | |
| clsEPmenu | clsPropMenu/ | Menu |
| | clsPropMenuDesc | |
| clsPerformer | clsPropPerformer/ | Menu component |
| | clsPropMenuPerformerDesc | |
| System.Windows.Forms. | clsPropMouseButton/ | |
| MouseButtons | clsPropMouseButtonDesc | |
| MultiLangString | clsPropMultiLangString/ | Multi-language string |
| | clsPropMultiLangStringDesc | |
| Int | clsPropPage/clsPropPageDesc | Represent a page |
| System.Windows.Forms. | clsPropPageBorder/ | |
| FormBorderStyle | clsPropPageBorderDesc | |
| string | clsProperty/ | Password |
| | clsPropPasswordDesc | |
| float | clsPropPercent/ | Percentage |
| | clsPropPercentDesc | |
| clsPerformer | clsPropPerformer/ | component |
| | clsPropPerformerDesc | |
| clsPerformerProp | clsPropPerformerProp/ | Represent a property of a |
| | clsPropPerformerPropDesc | component |
| System.Drawing.Point | clsPropPoint/clsPropPointDesc | |
| enumPrintOption | clsPropPrintOption/ | Print option |
| | clsPropPrintOptionDesc | |
| System.Drawing. | clsPropRect/clsPropRectDesc | |
| Rectangle | | |
| System.Windows.Forms. | clsPropRightToLeft/ | |
| RightToLeft | clsPropRightToLeftDesc | |
| clsRunData | clsPropRunData1/ | Represent a variable the |
| | clsPropRunData1Desc | application developer creates |
| clsRunData[] | clsPropRunData/ | Variable collection |
| | clsPropRunDataDesc | |
| clsScroll | clsPropScroll/ | Represent scroll attributes |
| | clsPropScrollDesc | |
| System.Windows.Forms. | clsPropScrollbars/ | Scroll bar |
| ScrollBars | clsPropScrollbarsDesc | |
| System.Drawing.Size | clsPropSize/clsPropSizeDesc | |
| enumPicSizeMode | clsPropSizeMode/ | Picture box size mode |
| | clsPropSizeModeDesc | |
| clsTextTemplate | clsPropString/ | Text template |
| | clsPropStringDesc | |
| System.Drawing. | clsPropTextAlign/ | |
| ContentAlignment | clsPropTextAlignDesc | |
| System.Windows.Forms. | clsPropToolBarAppearance/ | |
| ToolBarAppearance | clsPropToolBarAppearanceDesc | |
| ValToolbarButtons | clsPropToolbarButtons/ | Toolbar buttons |
| | clsPropToolbarButtonsDesc | |
| System.Windows.Forms. | clsPropToolBarButtonStyle/ | |
| ToolBarButtonStyle | clsPropToolBarButtonStyleDesc | |
| System.Windows.Forms. | clsPropToolbarTextAlign/ | |
| ToolBarTextAlign | clsPropToolbarTextAlignDesc | |
| clsTransColorKey | clsPropTransColorKey/ | Transparent color key |
| | clsPropTransColorKeyDesc | |
| System.Windows.Forms. | clsPropWinState/ | |
| FormWindowState | clsPropWinStateDesc | |
| ArrayList | PropArrayList/ | |
| | PropArrayListDesc | |
| ClientDate | PropClientDate/ | Date and time configurable by |
| | PropClientDateDesc | user |
| EPConnectionString | PropConnect/ | Database connection |
| | PropConnectDesc | |
| DataBind | PropDataBind/ | Data binding to field |
| | PropDataBindDesc | |
| DataBind | PropDataBind/ | Data binding to table |
| | PropTableBindDesc | |
| DTSQuery | PropDataSource/ | Data source for data transfer |
| | PropDataSourceDesc | |
| DropData | PropDropData/ | Data in a drag/drop operation |
| | PropDropDataDesc | |
| DropTypes | PropDropTypes/ | Data types in a drag/drop |
| | PropDropTypesDesc | operation |
| DTDest | PropDTDest/PropDTDestDesc | Destination for data transfer |
| TransMethod | PropDTMethod/ | Data transfer method |
| | PropDTMethodDesc | |
| enumDTType | PropDTType/PropDTTypeDesc | Data transfer type |
| EPField | PropField/PropFieldDesc | Database field |
| FieldList | PropFields/PropFieldsDesc | Database field list |
| int | clsProperty/ | Image index for an image list |
| | PropImageIndexDesc | |
| EPIniFile | PropINIfile/PropINIfileDesc | Config file |
| string | PropIniSect/PropIniSectDesc | Section name for a config file |
| bool | PropKeyTest/PropKeyTestDesc | Test keyboard value. The user |
| | | may specify key codes for test. |
| | | The property value is true if |
| | | key pressed is among the |
| | | specified key codes. |
| MessageBoxButtons | PropMessageBoxButtons/ | |
| | PropMessageBoxButtonsDesc | |
| MessageBoxIcon | PropMessageBoxIcon/ | |
| | PropMessageBoxIconDesc | |
| int | PropPageAttr/ | The user may specify a page. |
| | PropPageAttrDesc | At runtime this property value |
| | | is true is the page is loaded in |
| | | memory. |
| string | PropPassword/ | Password |
| | PropPasswordDesc | |
| PivotDefine | PropPivotDef/ | Pivot table definition |
| | PropPivotDefDesc | |
| EPQuery | PropQuery/PropQueryDesc | Database query |
| EPParentTable | PropRelation/ | Parent table in a 1 - many |
| | PropRelationDesc | relations |
| System.Environment. | PropSpecialFolder/ | |
| SpecialFolder | PropSpecialFolderDesc | |
| SQLNoneQuery | PropSQLNoneQuery/ | Database command |
| | PropSQLNoneQueryDesc | |
| StoredProc | PropStoredProc/ | Database stored-procedure |
| | PropStoredProcDesc | |
| string | PropVariableName/ | Variable name |
| | PropVariableNameDesc | |

Base Method Class

Methods of a software component usually are defined by a static array. Each array element is a clsMethod object or its derived object.

clsMethod is the base class for all method classes.

Attributes:

//Method implementation by Limnor system
//index into the method array of a component
protected int nIndex=0;
//method name
protected string sMethodName=“”;
//method description
protected string sMethodDesc;
//parameter count
protected int count=0;
//parameter names
protected string[ ] ParamNames;
//parameter descriptions
protected string[ ] ParamDescs;
//parameter data types represented by layer-3 property implementation
protected clsPropertyDesc[ ] parameters = null;
//set when IPerformer.getmethod is called
public IPerformer owner=null;

Constructor:

/// <summary>
/// Constructor for creating method object in a component
/// </summary>
/// <param name=“name”>Method name</param>
/// <param name=“desc”>Method description</param>
/// <param name=“idx”>Method index into the method array of
the component</param>
/// <param name=“nParamCount”>Parameter count</param>
public clsMethod(string name,string desc,int idx,int nParamCount)

Create Parameters:

/// <summary>
/// This function should be called for each parameter of the method
/// </summary>
/// <param name=”index”>parameter index</param>
/// <param name=“name”>parameter name</param>
/// <param name=“desc”>parameter description</param>
/// <param name=“propDesc”>parameter data type</param>
public virtual void DefineParameter(int index,string name,string
desc,clsPropertyDesc propDesc)

Other functions:

/// <summary>
/// This function is used to set the parameter types for the method
/// </summary>
/// <param name=“index”>parameter index</param>
/// <param name=“o”>defines the parameter type</param>
public virtual void setParameterType(int index,clsPropertyDesc o);
/// <summary>
/// gets parameter type as a property description class
/// </summary>
/// <param name=“index”>Parameter index</param>
/// <returns>parameter type</returns>
public clsPropertyDesc getParameterType(int index);
/// <summary>
/// sets parameter value
/// </summary>
/// <param name=“index”>parameter index</param>
/// <param name=“o”>parameter value</param>
public virtual void setParameterValue(int index,object o);
/// <summary>
/// gets parameter value
/// </summary>
/// <param name=“index”>parameter index</param>
/// <returns>parameter value</returns>
public virtual object getParameterValue(int index);
/// <summary>
/// Method index
/// </summary>
public int Index
/// <summary>
/// Parameter count
/// </summary>
public int ParamCount
/// <summary>
/// Method name
/// </summary>
public string MethodName
/// <summary>
/// Method description
/// </summary>
public string MethodDesc
/// <summary>
/// Get parameter name
/// </summary>
/// <param name=“index”>parameter index</param>
/// <returns>parameter name</returns>
public string GetParameterName(int index)
/// <summary>
/// Get parameter description
/// </summary>
/// <param name=“index”>parameter index</param>
/// <returns>parameter description</returns>
public string GetParameterDesc(int index)
/// <summary>
/// This function is called at design time when creating an
action using this method.
/// This function is called before the platform display the dialogue box for
choosing method parameters.
/// This function is called for each parameter.
/// The method object may use this chance to initialize parameters
in special ways or to build relations between parameters
/// </summary>
/// <param name=“objAction”>the action to create</param>
/// <param name=“index”>parameter index</param>
/// <param name=“actParamDescs”>parameter array</param>
public virtual void OnInitParameter(clsAction objAction,int
index,clsPropertyDesc[ ] actParamDescs)
/// <summary>
/// This function is called at design time when creating an action
using this method.
/// This function is called after the user changes a parameter for the action.
/// It gives the method a chance to build correlations between parameters
/// and give the owner some notifications
/// </summary>
/// <param name=“objAction”>the action to create</param>
/// <param name=“index”>parameter index indicating the parameter
changed</param>
/// <param name=“actParamDescs”>parameter array</param>
public virtual void OnParameterSet(clsAction objAction,int
index,clsPropertyDesc[ ] actParamDescs)
/// <summary>
/// The function is called by the platform before method parameter
selection UI is displayed.
/// give a method to initialize the parameters.
/// </summary>
/// <param name=“objAction”>The action object which will invoke
the method</param>
/// <param name=“actParamDescs”>Parameters to be set. It specifies
data types; ObjAction.methodParams specifies data values.</param>
public virtual void OnHookAction(clsAction
objAction,clsPropertyDesc[ ] actParamDescs)

Sample Method Object

For a Label component, one useful method is for setting the Text property of the label component. Because a method object of a component is used at design time by the user to create action objects, usually method objects in a component are static. For example,

const int MethodCount = 8;
static clsMethod[ ] objMethods = new clsMethod[MethodCount];

Each method object is created in a static constructor, setting method name, method description, and method parameters, for example:

objMethods[IDM_SetText] = new clsMethod(“SetText”,“Set Text of the
object.”,IDM_SetText,1);
objMethods[IDM_SetText].DefineParameter(0,“Text”,“The text to
set.”,new clsPropMultiLangStringDesc(0,false,“”));

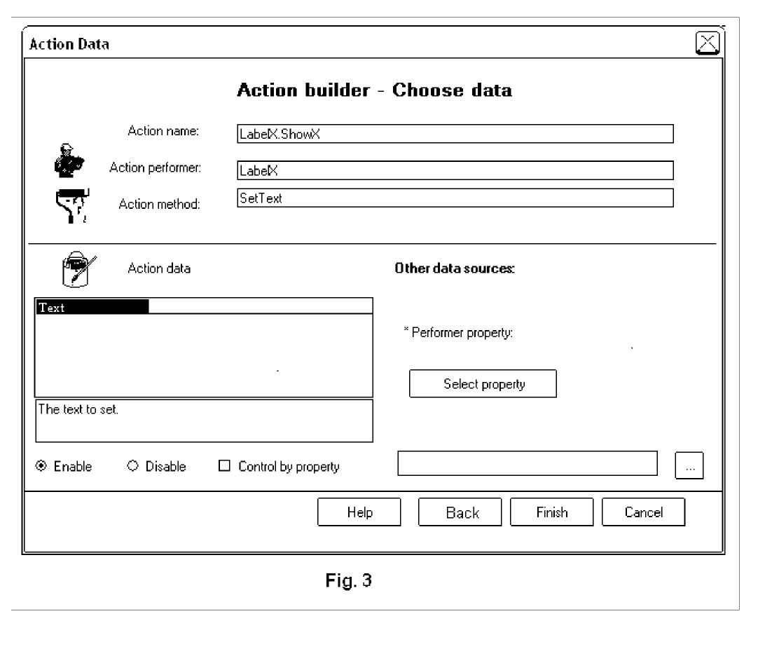

The Action-Data dialogue box is for setting action parameters. This dialogue box uses layer-3 property implementation of the method parameters for the user to select property values as action parameters. FIG. 3 shows this dialogue box for setting the “Text” parameter of an action using this “SetText” method.

Event Implementation

clsEPEvent class is a simple event class implemented in Limnor.

/// <summary>
/// Event without parameter
/// Note that other events are not derived from this class
/// </summary>
public class clsEPEvent : IEvent, ICloneable

An event class must implement IEvent interface and ICloneable interface.

Attributes:

protected clsEPBaseEvent objEvent = null;
protected static EPSTDEventArgs args=new EPSTDEventArgs( );

An event class must have a clsEPBaseEvent class, as objEvent member above. The major functionality of event class is done by objEvent member.

If an event class has event arguments then it should be a static member derived from EPSTDEventArgs, as args above. EPSTDEventArgs is for events without event arguments. If we define an event class which has event arguments then we need to derive a new class from EPSTDEventArgs.

Constructor:

/// <summary>
/// Event class constructor
/// </summary>
/// <param name=“ID0”>event ID</param>
public clsEPEvent(int ID0)
{
objEvent = new clsEPBaseEvent(ID0);
}

We must pass the event ID into the clsEPBaseEvent object objEvent.

For example, the DataTable component uses clsEPEvent class to create following event objects:

clsEPEvent eCursorMove = new clsEPEvent(IDE_CursorMove);
clsEPEvent eDragEnter = new clsEPEvent(IDE_DragEnter);
clsEPEvent eDragOver = new clsEPEvent(IDE_DragOver);
clsEPEvent eDragLeave = new clsEPEvent(IDE_DragLeave);
clsEPEvent eDragDrop = new clsEPEvent(IDE_DragDrop);
clsEPEvent eDropMe = new clsEPEvent(IDE_DropMe);

IEvent interface is implemented through objEvent object:

```
clsEPBaseEvent( ) IEvent.getBaseEvent( )
{
      return objEvent;
}
int IEvent.ID
{
      get{return objEvent.ID;}
}
EPSTDEventArgs IEvent.getArgs( )
{
      return args;
}
bool IEvent.hasHandler( )
{
      return objEvent.hasHandler( );
}
string IEvent.handlerName( )
{
      return objEvent.EventHandlerName;
}
```

Fire event:

/// <summary>
/// Call this function to fire Limnor event.
/// </summary>
/// <param name=“sender”>It should be the component firing
the event</param>
/// <param name=“e”>It is not used. It can be null.</param>
public void epHandler(object sender, System.EventArgs e)

In component code, when it is time to fire the event, call the above function. For example:

eCursorMove.epHandler(this,null);

Or hook this function directly to an event:

this.Activated += new System.EventHandler(eActivate.epHandler);

Layer-3 Property as Event Argument

Here we use an example to show how this technique is used. Suppose we make NET Form class into a component for codeless programming. When a mouse event fires we want to expose mouse position for codeless programming. We do it by exposing the mouse position as component properties.

Suppose propDescs is an array of clsPropertyDesc objects representing the properties for the component, ID-X is the array index for the property of horizontal mouse position and ID_Y is the array index for the property of vertical mouse position. These two properties are created in the component by the following code:

propDescs[ID_X] = new clsPropertyDesc(ID_X,false,0);
propDescs[ID_X].bReadOnly = true;
propDescs[ID_Y] = new clsPropertyDesc(ID_Y,false,0);
propDescs[ID_Y].bReadOnly = true;

Notes that bReadOnly is an attribute for layer-3 property implementation. We set it to true here because mouse position is read-only in this implementation of the component. If we implement code to set mouse position programmatically for the component then we may set the properties as not read-only.

In mouse events we save mouse event arguments to a component variable, for example:

```
/// <summary>
/// called when mouse moves
/// </summary>
/// <param name=“e”>event arguments</param>
protected override void
OnMouseMove(System.Windows.Forms.MouseEventArgs e)
{
      //save event arguments to a component variable
      eMouseCurrent = e;
      //firing Limnor events
      eMouseMove.epMouseHandler(this,e);
}
```

When the mouse position is needed in the application, we set the property values based on the event arguments. This is the time when the follow ing function for IProperties interface is called:

clsPropertyDesc this [int index]{get;}

So we set mouse position to the properties in this function:

```
clsPropertyDesc IProperties.this [int index]
{
  get
  {
    switch(index)
    {
    ......
    case ID_X:
    if( eMouseCurrent != null )
    {
      propDescs[index].objProperty.setProperty(eMouseCurrent.X);
    }
    else
    {
      propDescs[index].objProperty.setProperty(0);
    }
    break;
    case ID_Y:
    if( eMouseCurrent != null )
    {
      propDescs[index].objProperty.setProperty(eMouseCurrent.Y);
    }
    else
    {
      propDescs[index].objProperty.setProperty(0);
    }
    break;
    ......
    }
  }
}
```

To show the use of event arguments in codeless programming, we use codeless programming to create an application which shows a form and uses two label components to display mouse position (x, y). When the mouse is moving on the form, the mouse position is displayed in the label components.

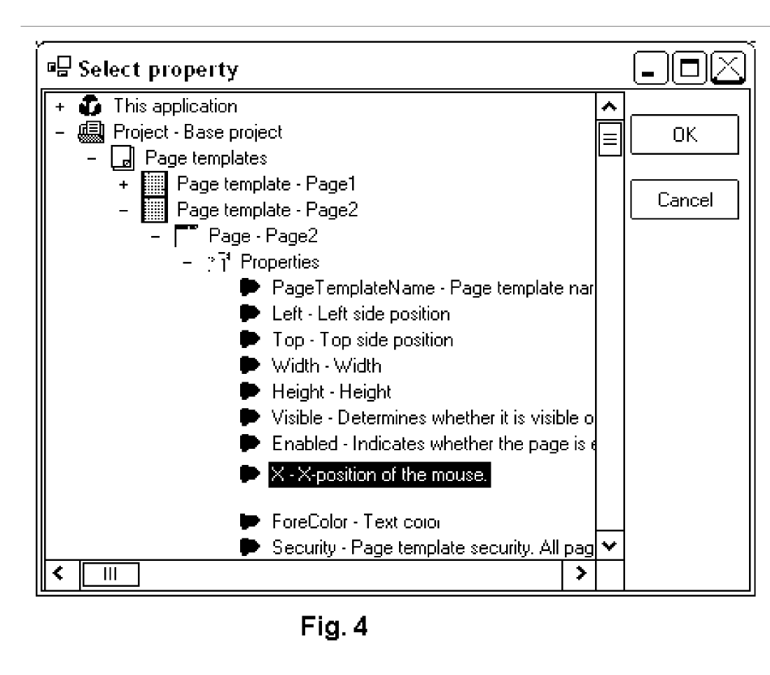

FIG. 3 and FIG. 4 show the making of an action object using SetText method of a label component. This method has a parameter for the text to be assigned to the Text property of the label component. FIG. 4 shows that the property X of the form component, which is the x-position of the mouse, is selected by the user as the action parameter. The action object name is LabelX.ShowX. In the same way, we make an action object named LabelY.ShowY which uses SetText method of another label component to show property Y of the form component. These two action objects form an action list object named ShowMousePosition.

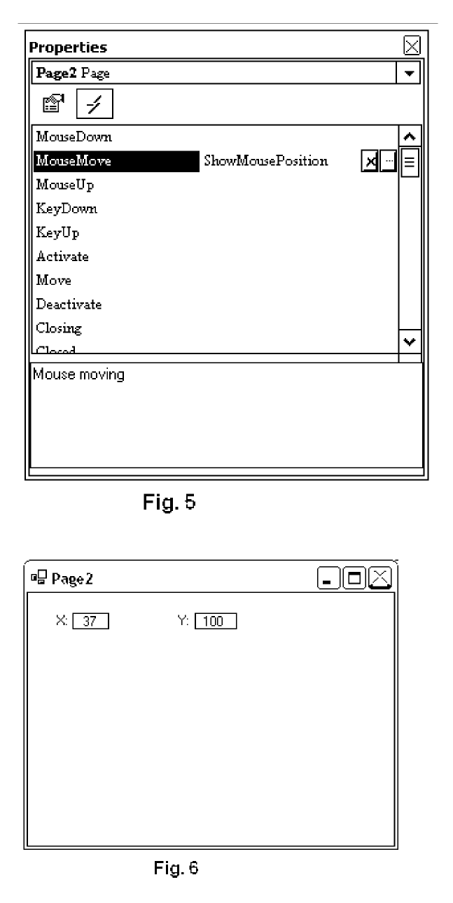

FIG. 5 shows that the action list object ShowMousePosition is linked to MouseMove event of the form component.

Our codeless programming is done. Run the application, move mouse on the form, we can see that the two label components show current mouse position while the mouse is moving.

FIG. 6 shows a snapshot of one moment of mouse movement.

Event Map

In developing an application when the user links an action object or an action list object to an event, it actually links the event firing software component to the action performing components. When an application runs, one component fires an event and action performer components linked to that event start performing tasks. This forms the application flow. To graphically show application flows, we may use icons to represent all software components used in an application and draw lines from event firing components to action performing components.

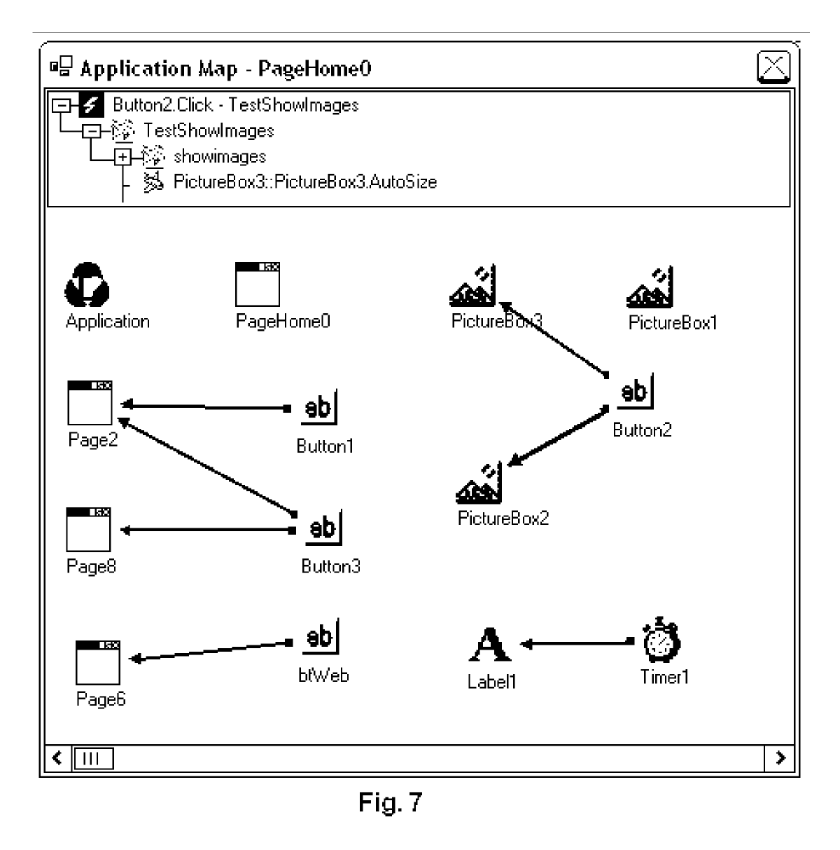

FIG. 7 shows an event map of an application.

What is claimed is:

1. A method for creating a property implementation technique for software components for the purpose of generic-purpose codeless programming; the method implemented on a computer system having persistent storage, a display screen and one or more input devices, the input devices controllable by a user to create visual representations of applications on the display screen, the method comprising following steps:
A. Every property of the software component is implemented by a base property description class (PDC) or a property description class derived from the base property description class; this property description class includes attributes relating to how the property is to be used by the software component at application design time, including controlling how the property is displayed, how the property value is set by the user interactively, whether the property is a component name, whether the property is a file name, and whether the property needs special handling at design time when the user is doing codeless programming; the PDC must include a member which is a base property class (PC) or a property class derived from the base property class; the PDC is Layer-3 of the property implementation;
B. The property class (PC) includes attributes about the property value including a flag indicating whether the property is a multi-valued property (and thus needs additional indexing to retrieve property value), how to retrieve property value, and the software component the property belongs to; and other property value attributes describing the value; the property class must include a member which is used as the property value (PV); the PC is Layer-2 of the property implementation;
C. The property value (PV) can be of any data type; the PV is usually the attributes or states of the software component the property belongs to, or is an value used in action parameter; the PV is Layer-1 of the property implementation;
D. The constructor of PDC creates its PC object; the constructor of PC creates its PV object; in this way it is guaranteed that a PDC object has the PC object it knows how to handle, and a PC object has the PV object it knows how to handle; for every type of PV, we need to use a corresponding type of PC to hold it; for every type of PC, we need to use a corresponding PDC to hold it; but the relationships do not need to be one-to-one; many types of PC may hold a same type of PV; many types of PDC may hold a same type of PC;
E. The retrieving of a software property value is by a virtual function of the corresponding property class; the virtual function returns the property value (PV) or the value the PV pointing to if the PV points to another value.

2. The method of claim 1 further comprising the step of:
F. While a property value (PV) can be of any data type one particular data type can be a class pointing to a property of a software component; the retrieving of a property value is through the virtual function of the property class (PC) defined in step E; the virtual function returns the software property value pointed to by the PV, not the PV itself. This relationship can be explained in following example:

| | |
|---|---|
| Example conditions | Assumptions: |
| | 1. Suppose the function name of the virtual |
| | function stated in step E is GetPropertyValue. |
| | 2. pc0 is an object of Property Class; |
| | 3. pv0 is the PV member of pc0; |
| | 4. pc1 is the PC member of software object s1's |
| | first property; |
| | 5. pv1 is the PV member of pc1; |
| | 6. pv0 points to the first property of software |
| | object s1. |
| | Example Purpose: show how the virtual function stated in |
| | Step E is working in the case of step F for object pc0. |
| Example 1: pv1 = 5 | pc0.GetPropertyValue( ) returns 5 by following process: |
| | The function detects that pv0 points to the first property |
| | of software object s1 so it returns pc1.GetPropertyValue( ) |
| | as stated by step E above. Because pv1 = 5, |
| | pc1.GetPropertyValue( ) returns 5, and thus |
| | pc0.GetPropertyValue( ) returns 5. |
| Example 2: pv1 | pc0.GetPropertyValue( ) returns 8 by following process: |
| points to a property | The function detects that pv0 points to the first property |
| with its PC object | of software object s1 so it returns pc1.GetPropertyValue( ) |
| pc2, pc2's PV object is pv2 | as stated by step E above; |
| and pv2 = 8 | The function pc1.GetPropertyValue( ) detects that pv1 is |
| | pointing to a property with pc2 as its PC member so it |
| | returns pc2.GetPropertyValue( ); |
| | The function pc2.GetPropertyValue( ) returns pv2 which is |
| | 8, and thus pc1.GetPropertyValue( ) returns 8, and thus |
| | pc0.GetPropertyValue( ) returns 8. |

This particular property value type can be used in all data transferring between components.

3. The method of claim 1 further comprising the step of:
G. Methods of a software component are implemented by method objects; the method class includes method parameters; the method parameters are implemented by objects of property description classes (PDC);
H. At design time, the user creates action objects based on methods of software components. The action class is defined by a software component, an indicator indicating the method of the software component, and objects of property class (PC) as action parameters; the software component in the action object is called the action performer; an action object has an “Enabled” attribute which can be assigned a component property by the user as part of codeless programming tasks; at runtime the “Enabled” attribute determines whether the action should be executed when the action object is launched by events;
I. Because the method parameters are PDC objects, at design time the user uses the design time features of PDC objects to specify action parameters; the specified action parameters are saved to the action object using the PC objects of the PDC objects;
J. Each software component supporting codeless programming supports a virtual/interface function to process action objects; the function uses the PC objects of the action object to retrieve property values as method parameters; the value retrieving is done in a way stated in step E and step F.

4. The method of claim 1 further comprising the step of:
K. Each software class supporting codeless programming may fire events; when firing an event the event arguments, for example, mouse position for a mouse event, may be placed in properties of the software component; at design time the user may use the design time features of PDC objects of the properties of the software component to do codeless programming involving the usages of event arguments; at runtime the event argument values are retrieved via PC objects of the properties of the software class, in a way stated in step E and step F;
L. The user links action objects to an event of a software component in an orderly manner; at runtime when an event occurs all action objects linked to the event are executed one by one in the order; the execution of an action object is to pass the action object to the virtual/interface function of its action performer (see step J); the virtual/interface function of the action performer gets the method indicator from the action object, and use step E and step F to get values from PC objects as method parameters; and uses these data to perform intended tasks;
M. Action objects may form an ordered list called action list; thus in step L, the user may link an action list object to an event; executing an action list object is to execute each action object one by one in the order of the action objects in the list; an action list object has an “Enabled” attribute which can be assigned a component property by the user as part of codeless programming tasks, at runtime the “Enabled” attribute determines whether the action list object should be executed when the action list object is launched by events.
